(19) United States
(12) Patent Application Publication
(10) Pub. No.: US 2007/0048424 A1
(43) Pub. Date: Mar. 1, 2007

(54) Liquid composition of 2-Isopropyl-N,2,3-trimethylbutyramide and N-Ethyl-p-menthane-3-carboxamide, its preparation method and its applications as a cooling agent and flavor enhancer

(76) Inventors: Ashok K. Moza, Baytown, TX (US); Hong Sun, Baytown, TX (US); John C. Leffingwell, Baytown, TX (US); Diane Leffingwell, Baytown, TX (US); Stephen Rohde, Baytown, TX (US)

Correspondence Address: Qaroma Inc.;Subsidiary of Chemicals Incorporated, 12321 Hatcherville Road, Baytown, TX, 77521, US

(21) Appl. No.: 11/217,188

(22) Filed: Sep. 1, 2005

(51) Int. Cl. A23L 1/22

(52) U.S. Cl. 426/534

(57) ABSTRACT

Disclosed is a liquid composition containing N-Ethyl-p-menthane-3-carboxamide and 2-Isopropyl-N,2,3-trimethylbutyramide (popularly known as WS-3 and WS-23 respectively), its preparation and its applications as a cooling sensate and as a flavoring agent. The present invention provides a composition characterized in that it comprises N-Ethyl-p-menthane-3-carboxamide and 2-Isopropyl-N,2,3-trimethylbutyramide in a ratio by weight in the range of 60/40 to 30/70 with the corresponding crystallization point being below 15° C. Preferably a weight ratio of 52/48 to 42/58 is employed corresponding to a crystallization point below −20° C. Such compositions have the advantages of being liquid at room temperature, easy to use as a cooling agent or a flavoring agent with no need to melt the normally crystalline forms of 2-Isopropyl-N,2,3-trimethylbutyramide (melting point 62° C.) and N-Ethyl-p-menthane-3-carboxamide (melting point 98.7° C.). The liquid cooling compositions herein described not only saves handling time, but also simplifies manufacturing processes by eliminating the need for extensive dust control procedures and can be used in cold processes at room temperature. These liquid compositions are effective not just as cooling agents, but at low levels act as flavor and salt enhancers.

### BACKGROUND OF THE INVENTION

The present invention relates to a liquid composition with cooling sensate properties comprised of two known chemical cooling sensates that are individually crystalline materials above 610° C.=141.80° F. and applications thereof.

N-Ethyl-p-menthane-3-carboxamide (also known under the tradenames WS-3, Framidice 3, WINSENSE WS-3, Menthol Carboxamide and ICE 3000 COOLING SENSATE) is a known cooling agent which is crystalline at room temperature and possesses a melting point generally above 82° C.=179.6° F. and when highly purified having a melting point of 98.7° C.=209.60° F. N-Ethyl-p-menthane-3-carboxamide is an approved flavorant having a FEMA GRAS No. 3455 and a EU Flavis No. 16.013 and a Council of Europe No. 2298. The preparation and utilization as a cooling agent is described in U.S. Pat. No. 4,150,052 by Watson, et al. dated Apr. 17, 1979, assigned to Wilkinson Sword Limited. N-Ethyl-p-menthane-3-carboxamide has a physiological cooling sensation which is about 50% stronger than (−)-menthol.

2-Isopropyl-N,2,3-trimethylbutyramide (also known under the tradenames WS-23, WINSENSE WS-23, and ICE 3000 COOLING SENSATE) is a known cooling agent which is crystalline at room temperature and possesses a melting point of 62° C.=143.6° F. Isopropyl-N,2,3-trimethylbutyramide is an approved flavorant having a FEMA GRAS No. 3804 and a EU Flavis No. 16.053. The preparation and utilization as a cooling agent is described in U.S. Pat. No. 4,230,688 by Rowsell, et al. dated Oct. 28, 1980, assigned to Wilkinson Sword Limited. Isopropyl-N,2,3-trimethylbutyramide has a physiological cooling sensation which is about 75% as compared to that of (−)-menthol.

The chemistry and cooling properties of cooling agents has been reviewed by Mark Erman [Progress in Physiological Cooling Agents, Perfumer & Flavorist, Volume 25 (No. 8), 34-50 (2004)].

Considerable interest has been shown for the development of convenient liquid sellable forms of cooling agents with little or no solvent. For example, blends of (−)-menthol and highly purified (−)-Isopulegol have been developed that remain liquid at 0° C. (Yamamoto, T. and Ohta, H., U.S. Pat. No. 5,663,460, Sep. 2, 1997). At a ratio of 55/45 (−)menthol to (−)-isopulegol, the solution remains liquid to 0° C. whereas at a ratio of 60/40 the solution partially crystallizes.

Similarly, it has been shown that a 50:50 blend of (−)-menthol and menthyl lactate is a liquid at room temperature and has a crystallization point of 8.2° C. (Su, Evelyn G. and Wang, Chang-Guo, U.S. Pat. No. 6,897,195, May 24, 2005). Further, In C. Galopin, E. Moraes, and L. Tigani (in PCT WO 2004/037764, May 6, 2004)

It is known that paramethane carboxamides (e.g. N-Ethyl-p-menthane-3-carboxamide) are very much prone to crystallization from their solutions in other cooling agents (Erman, Perfumer & Flavorist, Volume 25 (No. 8), 34-50, 2004). C. Galopin, E. Moraes, and L. Tigani (in PCT WO 2004/037764, May 6, 2004) have attempted to solve this problem by preparing solutions consisting essentially of menthyl lactate and menthol carboxamide dissolved in a solvent, such as propylene glycol. In preferred embodiments, menthyl lactate is present in amounts of from 50% to 60% by weight, menthol carboxamide (=N-Ethyl-p-menthane-3carboxamide) is present in amounts of from 10% to 20% by weight and of the total solution with the solvent (propylene glycol) being present in amounts of 25% to 30% by weight of the total solution. Such solutions are stable at room temperature and down to normal refrigeration temperatures, i.e., 4° C.

In each of the foregoing examples, based on generally accepted published cooling strengths, the calculated cooling power is less than is described in this invention. For example, a 50:50 blend of (−)-menthol and menthyl lactate has the cooling power of 0.72 compared to menthol with a value of 1.0. A 55:45 blend of (−)-menthol and (−)-isopulegol has a cooling power of 0.66 compared to menthol with a value of 1.0. A blend of 20:55:25 of menthol carboxamide: menthyl lactate: propylene glycol has a cooling power of 0.54 compared to menthol with a value of 1.0.

In this invention, liquid blends of 2-Isopropyl-N,2,3-trimethylbutyramide and N-Ethyl-p-menthane-3-carboxamide that do not crystallize at−20° C. can be achieved that possess a calculated cooling power of 1.06 to 1.14 compared to menthol with a value of 1.0.

Relative to the use of cooling compounds, not for cooling, but as flavor enhancers for foodstuffs and beverages, very few specific examples are available. It has, however, been shown that N-Ethyl-p-menthane-3-carboxamide can act as a flavor enhancer in candies for flavors of honey, citrus-spice, herbal and apple when used at 20 ppm in the finished candy. Similarly, in chewing gum at levels of 200 ppm and 400 ppm, a citrus flavor and a cinnamon flavor were enhanced (S. A. Barcelon, J. J. Keifer, H. Olaya and S. J. Luo, PCT WO 99107235, Feb. 9, 1999).

In this invention, we disclose that for many foodstuffs and beverages significant flavor enhancement can be achieved at levels of 1-10 ppm of the liquid cooling compositions herein described. Nowhere, in the prior art, is it mentioned that cooling agent compositions enhance the salty taste of foodstuffs. In this invention, we disclose that for many foodstuffs the saltiness perception is increased when using 1-10 ppm of the liquid cooling compositions herein described.

Further, whereas 2-Isopropyl-N,2,3-trimethylbutyramide (WS-23) has a more rapid sensory onset providing an initial burst of cooling (but with a shorter cooling time than WS-3), Ethyl-p-menthane-3-carboxamide (WS-3) has a somewhat slower onset time, but with a colder but smoother and more lingering cooling sensation than WS-23. In this invention, we disclose that the liquid blend compositions of this invention provide the added advantage of providing both rapid sensory onset and a long and smooth cooling sensation when used as coolants.

### OBJECTS OF THE INVENTION

An object of the present invention is to provide compositions containing 2-Isopropyl-N,2,3-trimethylbutyramide and N-Ethyl-p-menthane-3-carboxamide that are liquid at room temperature without any solvent or solubilizer, which can be added directly into formulations in a liquid form without heating and where such compositions are nearly odorless odor and have low volatility.

Another object of the present invention is to provide compositions that deliver excellent cooling with both rapid sensory onset and a long and smooth cooling sensation in formulations where they are used for a cooling effect.

A further object of the invention is to provide such liquid cooling compositions that provide flavor enhancement to foodstuffs and beverages when used at low levels where the cooling sensation is imperceptible or barely perceptible.

A further object of the invention is to provide such liquid cooling compositions that provide saltiness enhancement to foodstuffs when used at low levels where the cooling sensation is imperceptible or barely perceptible.

### SUMMARY OF THE INVENTION

The above objects of the present invention can be achieved by mixing 2-Isopropyl-N,2,3-trimethylbutyramide and N-Ethyl-p-menthane-3-carboxamide in a certain ratio so that it forms a mixture with a crystallization point of the composition below room temperature and thus exhibits a liquid form at room temperature.

The present invention provides compositions that deliver excellent cooling with both rapid sensory onset and a long and smooth cooling sensation in formulations where they are used for the cooling sensation.

Such liquid cooling compositions can be used for augmenting, enhancing or imparting a taste or to provide a cooling or refreshing effect in or to a cosmetic, skin care product, lip gloss, shampoo or other hair care products, cologne, shaving creme, after-shave lotion, deodorant, antiperspirant, dairy products, fruit ice preparation, salad dressings, salsas, soy sauces, soups, confectionery, mouth and throat lozenges, cough mixtures, decongestants, antacids, oral analgesics or other medicinal or pharmaceutical products, chewing gum, candy (including hard candy and soft candy), fondants, toothpaste, mouthwashes, mineral water, alcoholic beverage, non-alcoholic beverage, powdered beverage, or other foodstuffs, comprising the step of adding the liquid cooling compositions herein described either alone, or in spray-dried form, or in solvents such propylene glycol, alcohol, octyldodecanol, dipropylene glycol, triglycerides, isopropyl myristate, triacetin, triethyl citrate, benzyl alcohol, terpenes, olive oil, almond oil, hexyl laurate or as aqueous emulsions or as part of flavoring and fragrance concentrates.

Such liquid cooling compositions can also be used at low levels, wherein the cooling effect is imperceptible or barely perceptible, in foodstuffs and beverages, to provide flavor or/and saltiness enhancement.

Another object of the present invention is to provide compositions that deliver excellent cooling with both rapid sensory onset and a long and smooth cooling sensation in formulations where they are used for a cooling effect.

### DETAILED DESCRIPTION OF THE INVENTION

The present invention provides a composition containing 2-Isopropyl-N,2,3-trimethylbutyramide and N-Ethyl-p-menthane-3-carboxamide, with a ratio of 2-Isopropyl-N,2,3-trimethylbutyramide and N-Ethyl-p-menthane-3-carboxamide by weight lying in the range of 60:40 to 30:70 and a crystallization point lower than the room temperature of 15° C., preferably with a ratio of 2-Isopropyl-N,2,3-trimethylbutyramide and N-Ethyl-p-menthane-3-carboxamide by weight lying in the range of 52:48 to 42:58 and a crystallization point below −20° C.; and further preferably with a ratio of 2-Isopropyl-N,2,3-trimethylbutyramide and N-Ethyl-p-menthane-3-carboxamide by weight about 1:1 and the crystallization point below −20° C.

According to the present invention, the mixture of 2-Isopropyl-N,2,3-trimethylbutyramide and N-Ethyl-p-menthane-3-carboxamide is in a liquid form at room temperature, and therefore, can conveniently be added to formulations directly without heating thus saving time, energy and money when used in cold process manufacturing. Such compositions have the added benefit of being flowable liquids that possess a higher bulk density which reduces packaging costs.

One object of the present invention is achieved by the following procedure: 2-Isopropyl-N,2,3trimethylbutyramide is weighed into a container and then heated above its melting point of 62° C. With stirring, a certain weight of N-Ethyl-p-menthane-3-carboxamide is added into the same container according to a certain ratio. Stirring is continued until the resulting mixture becomes a clear, transparent liquid. Upon cooling the composition remains liquid at room temperature.

The present invention provides compositions that deliver excellent cooling with both rapid sensory onset and a long and smooth cooling sensation in formulations where they are used for the cooling sensation. The liquid cooling compositions of the invention provides a cooling sensation that is considered improved over either 2-Isopropyl-N,2,3-trimethylbutyramide or N-Ethyl-p-menthane-3-carboxamide alone.

Another object of the invention is achieved by providing flavor and/or saltiness enhancing effects from such compositions where said compositions are employed in foodstuffs and beverages at low levels wherein the cooling effect is imperceptible or barely perceptible. For this, a panel consisting of both professional flavorists and other individuals with sensory testing experience was employed. In each tasting session two samples were presented to the panelists in a randomized order to avoid presentation order effect. Panelists were asked to rate the samples as same or different. If different, panelists were asked to rate flavor intensity and to describe the difference. The flavor and/or saltiness enhancing effects are demonstrated for a number of foodstuffs and beverages.

### EXAMPLE 1

### Preparation of Liquid Cooling Compositions

a) Fifty grams of 2-Isopropyl-N,2,3-trimethylbutyramide flakes and 50 g of N-Ethyl-p-menthane-3-carboxamide were placed in a 200 ml beaker, and the mixture was heated to above 62° C. to melt the 2-Isopropyl-N,2,3-trimethylbutyramide. The mixture is then stirred until the resulting mixture becomes a clear, transparent liquid composition consisting of 50% of 2-Isopropyl-N,2,3-trimethylbutyramide and 50% N-Ethyl-p-menthane-3-carboxamide. The resulting liquid cooling composition here described is referred to hereafter as Liquid Sensate No. 1
b) Forty grams of 2-Isopropyl-N,2,3-trimethylbutyramide flakes and 60 g of N-Ethyl-p-menthane-3-carboxamide were placed in a 200 ml beaker, and the mixture was heated to above 62° C. to melt the 2-Isopropyl-N,2,3-trimethylbutyramide. The mixture is then stirred until the resulting mixture becomes a clear, transparent liquid composition consisting of 50% of 2-Isopropyl-N,2,3-trimethylbutyramide and 50% N-Ethyl-p-menthane-3-carboxamide. The resulting liquid cooling composition here described is referred to hereafter as Liquid Sensate No. 2.
c) 70 grams of 2-Isopropyl-N,2,3-trimethylbutyramide flakes and 30 g of N-Ethyl-p-menthane-3-carboxamide were placed in a 200 ml beaker, and the mixture was heated to above 62° C. to melt the 2-Isopropyl-N,2,3-trimethylbutyramide. The mixture is then stirred until the resulting mixture becomes a clear, transparent liquid composition consisting of 50% of 2-Isopropyl-N,2,3-trimethylbutyramide and 50% N-Ethyl-p-menthane-3-carboxamide. The resulting liquid cooling composition here described is referred to hereafter as Liquid Sensate No. 3

### EXAMPLE 2

The relationship between 2-Isopropyl-N,2,3-trimethylbutyramide and N-Ethyl-p-menthane-3-carboxamide ratios and the liquid-solid state at 25° C., 15° C., −5° C. and −20° C. was examined. The results are shown in Table 1 below.

TABLE 1

| | N-Ethyl-p- | | | | |
|---|---|---|---|---|---|
| 2-Isopropyl-N,2,3- | menthane-3- | | | | |
| trimethylbutyramide (%) | carboxamide (%) | 25° C. | 15° C. | −5° C. | −20° C. |
| 35 | 65 | solid | solid | solid | solid |
| 40 | 60 | liquid | liquid | partially | partially |
| | | | | crystalline | crystalline |
| 45 | 55 | liquid | liquid | partially | partially |
| | | | | crystalline | crystalline |
| 48 | 52 | liquid | liquid | liquid | liquid |
| 50 | 50 | liquid | liquid | liquid | liquid |
| 55 | 45 | liquid | liquid | liquid | liquid |
| 58 | 42 | liquid | liquid | liquid | liquid |
| 60 | 40 | liquid | liquid | partially | partially |
| | | | | crystalline | crystalline |
| 70 | 30 | liquid | liquid | partially | partially |
| | | | | crystalline | crystalline |
| 75 | 25 | solid | solid | solid | solid |

### EXAMPLE 3

### Preparation of an Herbal Type Mouthwash

A mouthwash formulation utilizing the liquid cooling composition from Example 1-a may be prepared as follows (Table 2):

TABLE 2

| | |
|---|---|
| 1,8-cineole | 0.92 |
| Thymol | 0.64 |
| Methyl salicylate | 0.60 |
| Liquid Sensate No. 1 | 0.40 |
| Ethyl Alcohol (95%) | 283.00 |
| Poloxamer 407 | 1.50 |
| Benzoic acid | 1.50 |
| Sodium benzoate | 1.00 |
| Caramel color | 0.10 |
| Water | 710.34 |
| | 1000.00 |

The flavor of this mouthwash is similar to a leading commercial mouthwash (Listerine® brand), but with slightly less minty connotations.

Listerine® is a registered trademark of Warner-Lambert Company LLC

### EXAMPLE 4

### Preparation of a Peppermint Type Mouthwash

A peppermint flavored mouthwash formulation utilizing the liquid cooling composition from Example 1-a may be prepared as follows (Table 3):

TABLE 3

| | |
|---|---|
| Ethyl Alcohol (95%) | 210.0 |
| Glycerin | 110.0 |
| Benzoic acid | 1.5 |
| Peppermint oil | 0.8 |
| Liquid Sensate No. 1 | 0.6 |
| Sodium benzoate | 1.0 |
| Sodium saccharin | 1.5 |
| Tween 80 | 1.5 |
| Water | 673.4 |
| | 1000.0 |

The flavor of this mouthwash is strongly minty and cooling with both rapid cooling sensory onset and a prolonged cooling sensation.

### EXAMPLE 5

### Flavor Enhancement of a Mild Salsa

A blend of 2-Isopropyl-N,2,3-trimethylbutyramide and N-Ethyl-p-menthane-3-carboxamide in a ratio of 2:3 (liquid cooling composition of Example 1-b) (Liquid Sensate No. 2), was added at a level of 5 ppm to a mild salsa (Tostito's® brand) and the taste compared to the control salsa without the additive. Panelists universally agreed that the overall flavor profile was significantly boosted and that the test product was significantly saltier. No cooling sensation was described by panelists.

To provide a quantitative estimation of the degree of flavor enhancement, the control salsa was diluted by adding 20 grams of water to 80 grams salsa. To this blend was added 5 ppm of the Liquid Sensate No. 2. When the flavor of the diluted salsa with the additive was compared to the undiluted control salsa, panelists were in agreement that the two samples were essentially identical in flavor level and degree of saltiness. No cooling sensation was described by panelists. Accordingly, the flavor enhancement was judged to be 25%.

Tostito's® is a registered trademark of Frito-Lay North America, Inc.

### EXAMPLE 6

### Flavor Enhancement of a Roasted Asian Sesame Dressing

Liquid Sensate No. 2 (Example 1-b), described previously, was added to a Roasted Asian Sesame Dressing (Cardini's® brand) at 10 ppm. When compared to the control dressing without additives panelists described the test product as being more flavorful, with a significantly saltier and vinegary taste. No cooling sensation was described by panelists.

Cardini's® is a registered trademark of T. Marzetti Company

### EXAMPLE 7

### Flavor Enhancement of a Low Sodium Chicken Broth

Liquid Sensate No. 2 (Example 1-b), described previously, was added to a low sodium chicken broth (Campbell's brand) at 2 ppm. When compared to the control broth without additives panelists described the test product as being more flavorful, with fuller mouth-feel and with a saltier taste. No significant cooling sensation was described by panelists.

Campbell's® is a registered trademark of CSC Brands LP

### EXAMPLE 8

### Flavor Enhancement of a Low Sodium Soy Sauce

Liquid Sensate No. 2 (Example 1-b), was added to a low sodium soy sauce (Kikkoman® Lite brand) at 3 ppm. When compared to the control soy sauce without additives panelists described the test product as definitely being more flavorful and with a saltier taste. No cooling sensation was described by panelists.

Kikkoman® is a registered trademark of Kikkoman Corporation

### EXAMPLE 9

### Flavor Enhancement of a Low Sodium Tomato Soup

Liquid Sensate No. 2 (Example 1-b), was added to a low sodium tomato soup with tomato pieces (Campbell's® brand) at 3 ppm. When tasted cold, panelists perceived no difference. When compared warm to the control soup without additives panelists described the test product as being more flavorful, with more tomato taste and with a saltier taste. No significant cooling sensation was described by panelists.

Campbell's® is a registered trademark of CSC Brands LP

### EXAMPLE 10

### Flavor Enhancement of a Beef Gravy

Liquid Sensate No. 2 (Example 1-b), was added to a commercial beef flavored gravy (Kroger® brand) at both 3 ppm and 6 ppm. In both cases, when compared to the control gravy without additives panelists described the test product as being more flavorful, with a more meaty taste and with a saltier taste. No significant cooling sensation was described by panelists.

Kroger® is a registered trademark of the Kroger Co. of Michigan

### EXAMPLE 11

### Flavor Enhancement of a Low Sodium Beef Bouillon

Liquid Sensate No. 2 (Example 1-b), was added to a low sodium beef bouillon [prepared by simmering 3.7 grams of a commercial low sodium beef bouillon cube (Wyler's® brand) in 1 cup (245 grams) of water] at 3 ppm. When compared to the control beef bouillon without additives panelists described the test product as being more flavorful, with a more meat-like taste and with a saltier taste. No significant cooling sensation was described by panelists.

Wyler's® is a registered trademark of BFC Investments, L.P. and is manufactured and marketed by the H.J. Heinz Co. L.P.

### EXAMPLE 12

### Flavor Enhancement of a Low Sodium Chicken Bouillon

Liquid Sensate No. 2 (Example 1-b), was added to a low sodium chicken bouillon [prepared by simmering 3.7 grams of a commercial low sodium chicken bouillon cube (Wyler's® brand) in 1 cup (245 grams) of water] at 3 ppm. When compared to the control beef bouillon without additives panelists described the test product as being more flavorful, with a more chicken-like taste and with a saltier taste. No significant cooling sensation was described by panelists.

Wyler's® is a registered trademark of BFC Investments, L.P. and is manufactured and marketed by the H.J. Heinz Co. L.P.

### EXAMPLE 13

### Flavor Enhancement of an Italian Salad Dressing

Liquid Sensate No. 2 (Example 1-b), was added to a Zesty Italian Salad Dressing (Kroger® brand) at 5 ppm. When compared to the control salad dressing without additives panelists described the test product as being more salty and tangy. No significant cooling sensation was described by panelists.

Kroger® is a registered trademark of the Kroger Co. of Michigan

### EXAMPLE 14

### Flavor Enhancement of Fat Free Catalina Salad Dressing

Liquid Sensate No. 2 (Example 1-b), was added to a Fat Free Catalina Salad Dressing (Kraft® brand) at 4 ppm. When compared to the control salad dressing without additives panelists described the test product as being more salty and tangy with an increase in tomato taste. No significant cooling sensation was described by panelists.

Kraft® is a registered trademark of Kraft Foods Holdings, Inc.

### EXAMPLE 15

### Saltiness Enhancement of a Squeeze Margarine

Liquid Sensate No. 2 (Example 1-b), was added to a Squeeze Margarine (Parkay® brand) at 4 ppm and 7 ppm. Panelists described the sample with 4 ppm as being no different than the control. When the sample with 7 ppm was compared to the control margarine without additives panelists described the test product as being more salty, and with a prolonged salty sensation. No significant cooling sensation was described by panelists.

Parkay® is a registered trademark of ConAgra Brands, Inc.

### EXAMPLE 16

### Flavor Enhancement of a Lemon-Lime Soda

A Lemon-Lime Soda was prepared as follows:

a) A Natural Lemon Lime oil with other natural flavors was prepared (Table 4).

TABLE 4

| | |
|---|---|
| Lemon Oil Calif. CP USP | 8458.00 |
| Oil Lime Distilled Mexican FCC | 1538.61 |
| alpha-Terpineol Natural | 1.22 |
| Citral Natural | 1.20 |
| Terpinenol-4 Natural | 0.29 |
| Lime Oil Distilled 5× | 0.14 |
| Eucalyptol NF FCC Natural | 0.12 |
| Linalool Natural | 0.11 |
| Oil Eucalyptus Globulus 80/85% | 0.10 |
| Natural Octanal (90%) | 0.07 |
| Citronellal 85/90% FCC Natural | 0.05 |
| Geraniol Natural | 0.05 |
| Natural Decanal (80%) | 0.04 |
| | 10000.00 |

b) Using the Lemon Lime WONF flavor oil from Example 16-a, a lemon-lime extract was prepared (Table 5):

TABLE 5

| | |
|---|---|
| Natural Lemon-Lime oil WONF | 116.6 |
| Ethyl Alcohol 190 Proof | 353.4 |
| Propylene Glycol | 176.6 |
| Water | 353.4 |
| | 1000 |

Procedure: Add the natural Lemon-Lime oil WONF oil to the alcohol & Mix. Then add the Propylene Glycol and mix well. Slowly add the water with mixing and mix well for 2 hours. Stop agitation and let sit overnight at 5° C. Separate the lower layer, add filter aid and filter clear. Yield of Extract is 866 grams.

c) Using the Lemon-Lime extract from Example 16-b, a lemon-lime bottlers syrup was prepared (Table 6):

TABLE 6

| | | |
|---|---|---|
| Water | 185.83 | grams |
| Sodium Benzoate | 0.59 | grams |
| High Fructose Corn Syrup 55 (77% solids) | 419.54 | grams |
| Citric acid (Anhydrous) | 3.60 | grams |
| Sodium Citrate (dihydrate) | 0.73 | grams |
| Lemon-Lime extract | 3.90 | grams |
| Syrup Yield | 614.19 | grams |

d) Using the lemon lime bottlers syrup from Example 16-c, a carbonated lemon-lime soda was prepared by weighing 61.42 grams of the syrup into a 10 fluid ounce soft drink bottle and adding carbonated water sufficient to make 10 fluid ounces of beverage. This corresponds to a 1+5 bottlers throw.

The finished lemon lime-soda exhibited the following specifications.

Beverage Brix=10.6 (by refractometer)

Beverage Carbonation=3.7 volumes CO₂ gas

Beverage Titratable acidity=18.5 ml of 0.1 Normal sodium hydroxide per 100 ml of degassed beverage.

e) Panelists evaluated the lemon-lime soda from Example 16-d versus samples prepared containing 7 ppm Liquid Sensate No. 2 (Example 1-b) at refrigeration temperatures. Panel results indicated that the product containing the liquid sensate had more citrus taste and was more refreshing. The beverage also possessed a slight lingering cooling sensation.

### EXAMPLE 17

### Flavor Enhancement of a Carbonated Cola Beverage

Liquid Sensate No. 2 (Example 1-b), was added to a commercial Cola (Coca-Cola® Brand) at 3 ppm. When compared, at refrigeration temperature, to the control cola without additives panelists described the test product as being more flavorful with an increase in the citrus flavor notes.

Coca-Cola® is a registered trademark of The Coca-Cola Company

### EXAMPLE 18

### Flavor Enhancement of a Carbonated Tonic Water

Liquid Sensate No. 2 (Example 1-b), was added to a commercial tonic water (Schweppes® Brand) at 3 ppm. When compared, at refrigeration temperature, to the control tonic water without additives panelists described the test product as being more flavorful with an increase in the citrus notes and a slight decrease in the “dry” aspects.

Schweppes® is a registered trademark of Schweppes International Limited

### EXAMPLE 19

### Flavor Enhancement of a Non-carbonated Lemon-Lime Sports Drink

Liquid Sensate No. 2 (Example 1-b), was added to a commercial lemon-lime sports drink (Gatorade® Brand) at 3 ppm. When compared, at room temperature, to the control drink without additives panelists described the test product as being more flavorful and refreshing with an increase in the citrus flavor notes.

Gatorade® is a registered trademark of Stokely-Van Camp, Inc.

### EXAMPLE 20

### Flavor Enhancement of a Coffee Flavored Liqueur

Liquid Sensate No. 3 (Example 1-c), was added to a commercial coffee flavored liqueur (Kahlúa® Brand) at 1 ppm, 4 ppm and 10 ppm. When compared to the control liqueur without additives panelists described the test product containing 1 ppm as being more flavorful with a significant increase in the coffee flavor notes and a prolonged coffee flavor sensation. In addition a slight increase in the alcohol impact sensation was perceived. The sample containing 4 ppm was also judged to have more coffee flavor, but with even more of an increase in the alcohol impact sensation. The sample with 10 ppm also had more coffee flavor but this was overshadowed by a further increase in the alcohol impact sensation.

Kahlúa® is a registered trademark of The Kahlúa Company

### EXAMPLE 21

### Flavor Enhancement of a Black Raspberry Flavored Liqueur

Liquid Sensate No. 3 (Example 1-c), was added to a commercial black raspberry flavored liqueur (Chambord® Brand) at 1 ppm and 4 ppm. When compared to the control liqueur without additives panelists described the test product containing 1 ppm as being more flavorful with an increase in the black raspberry flavor notes and with somewhat of a prolonged flavor sensation. In addition a slight increase in the alcohol impact sensation was perceived. The sample containing 4 ppm was also judged to have more black raspberry flavor, but with even more of an increase in the alcohol impact sensation.

Chambord® is a registered trademark of Chatam International Incorporated

### EXAMPLE 22

### Flavor Enhancement of a Peach Flavored Liqueur

Liquid Sensate No. 3 (Example 1-c), was added to a commercial peach flavored liqueur (Original Peachtree® Schnapps Brand) at 1 ppm and 4 ppm. When compared to the control liqueur without additives panelists described the test product containing 1 ppm as being more flavorful with an increase in the peach flavor notes. In addition a slight increase in the alcohol impact sensation was perceived. The sample containing 4 ppm was also judged to have more peach flavor, but with even more of an increase in the alcohol impact sensation.

Original Peachtree® Schnapps is a registered trademark of JOHS DE KUYPER & ZOON B. V.

### EXAMPLE 23

### Cooling Enhancement of a Bottled Water

Liquid Sensate No. 3 (Example 1-c), was added to a commercial bottled water (Kroger® Brand) at 6 ppm. When compared, at room temperature, to the control water without additives panelists described the test product as having a colder temperature sensation and possessing a slight lingering coolness. There was no change in the waters taste.

Kroger® is a registered trademark of the Kroger Co. of Michigan

1. A composition of matter for use as a cooling agent, flavor enhancer, saltiness enhancer or as a fragrance agent, comprising a stable liquid mixture of 2-Isopropyl-N,2,3-trimethylbutyramide and N-Ethyl-p-menthane-3-carboxamide with a weight ratio of 2-Isopropyl-N,2,3-trimethylbutyramide to N-Ethyl-p-menthane-3-carboxamide in the range of 60:40 to 30:70 with the corresponding crystallization point being below 150° C.

2. A composition of matter in accordance with claim 1 wherein said weight ratio of 2-Isopropyl-N,2,3-trimethylbutyramide to N-Ethyl-p-menthane-3-carboxamide is preferably in the range of 52:48 to 42:58 with the corresponding crystallization point being below −20° C.

3. A composition of matter in accordance with claim 2 wherein said weight ratio of 2-Isopropyl-N,2,3-trimethylbutyramide to N-Ethyl-p-menthane-3-carboxamide in a preferred weight ratio of 1:1 with the corresponding crystallization point being below −20° C.

4. A composition of matter for use as a cooling agent or flavor enhancer or saltiness enhancer in accordance with claim 1, wherein said weight ratio of said 2-Isopropyl-N,2,3-trimethylbutyramide to said N-Ethyl-p-menthane-3-carboxamide includes stereoisomers of N-Ethyl-p-menthane-3-carboxamide.

5. A method of manufacture of a composition of matter for use as a cooling agent, flavoring agent or fragrance agent comprising the following steps:
a) Weigh the 2-Isopropyl-N,2,3-trimethylbutyramide and N-Ethyl-p-menthane-3-carboxamide (in a ratio of 60:40 to 30:70) into a container.
b) Heat the mixture of 2-Isopropyl-N,2,3-trimethylbutyramide to N-Ethyl-p-menthane-3-carboxamide to above 62° C. and stir to liquefy.
c) Cool the liquefied mixture to room temperature wherein the mixture remains liquid and does not crystallize.

6. The method of manufacture in accordance with claim 5 wherein the weight ratio of 2-Isopropyl-N,2,3-trimethylbutyramide to N-Ethyl-p-menthane-3-carboxamide is in the range of 60:40 to 30:70.

7. The method of manufacture in accordance with claim 5 wherein the weight ratio of 2-Isopropyl-N,2,3-trimethylbutyramide to N-Ethyl-p-menthane-3-carboxamide is in the range of 52:48 to 42:58.

8. The method of manufacture in accordance with claim 5 wherein the weight ratio of 2-Isopropyl-N,2,3-trimethylbutyramide to N-Ethyl-p-menthane-3-carboxamide is 1:1.

9. The use of the liquid cooling compositions of claim 1 as flavor enhancers and saltiness enhancers in salsas wherein said compositions are employed at a rate of 1 ppm to 10 ppm in the finished salsa.

10. The use of the liquid cooling compositions of claim 1 as flavor enhancers and saltiness enhancers in soups and HVP based broths wherein said compositions are employed at a rate of 1 ppm to 10 ppm in the finished soup or broth.

11. The use of the liquid cooling compositions of claim 1 as flavor enhancers and saltiness enhancers in soy sauces wherein said compositions are employed at a rate of 1 ppm to 10 ppm in the finished soy sauce.

12. The use of the liquid cooling compositions of claim 1 as saltiness enhancers in margarines wherein said compositions are employed at a rate of 5 ppm to 10 ppm in the finished margarine.

13. The use of the liquid cooling compositions of claim 1 as flavor enhancers and saltiness enhancers in salad dressings and marinades wherein said compositions are employed at a rate of 1 ppm to 10 ppm in the finished salad dressings or marinades.

14. The use of the liquid cooling compositions of claim 1 as flavor enhancers in carbonated soft drinks wherein said compositions are employed at a rate of 1 ppm to 10 ppm in the finished carbonated soft drinks.

15. The use of the liquid cooling compositions of claim 1 as flavor enhancers in non-carbonated sport drinks wherein said compositions are employed at a rate of 1 ppm to 10 ppm in the finished non-carbonated sport drinks.

16. The use of the liquid cooling compositions of claim 1 as flavor enhancers in flavored alcoholic liqueurs wherein said compositions are employed at a rate of 1 ppm to 10 ppm in the finished flavored alcoholic liqueurs.

17. The use of the liquid cooling compositions of claims 1, 2 and 3 for imparting cooling sensations to the foodstuffs and beverages of claims 9 through 16 is specifically disclaimed.

18. The use of the liquid cooling compositions of claims 1, 2 and 3 to deliver excellent cooling with both rapid sensory onset and a long and smooth cooling sensation in formulations where they are used for providing cooling sensation.
